(19) United States
(12) Patent Application Publication
(10) Pub. No.: US 2006/0025093 A1
(43) Pub. Date: Feb. 2, 2006

(54) Broadcast metadata plug-in model

(75) Inventors: Alan E. Shield, Issaquah, WA (US); Shawn E. Pickett, Sammamish, WA (US); Glenn A. Curtis, Sammamish, WA (US); Thaddeus C. Pritchett, Edmonds, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/900,937

(22) Filed: Jul. 28, 2004

(51) Int. Cl. H04B 1/18

(52) U.S. Cl. 455/179.1

(57) ABSTRACT

A multi-receiving device receives broadcast transmission signals based on different transmission standards. A determination is made as to a particular transmission standard that is used by a received broadcast transmission signal, and the receiving device is configured as to the particular transmission standard in order to parse or process metadata included in the received broadcast transmission signal.

### TECHNICAL FIELD

This invention relates to devices capable of receiving multiple broadcast transmission signals are able to use their related transmission standard protocols which describe transmission standard, broadcaster, content information and scheduling information.

### BACKGROUND

Broadcast transmission signals make use of one of various transmission standards. A transmission standard defines how a broadcast transmission signal is broadcasted and further defines how the broadcast transmission signal is processed by a receiving device, including for example how the broadcast transmission signal may be separated into audio, video, and metadata, and how the metadata is used. Metadata may be in-band or out-band data. Furthermore, a transmission standard may define how information is extracted and used from metadata in the broadcast transmission signal.

Broadcast transmission signal data includes audio data, video data, and metadata. Meta-band data describes audio and video content provided in the audio and video data, and may also provide additional information. Additional metadata information may include information as to when a program is broadcasted; where a viewer may tune to the program broadcast (i.e., tuner frequency or channel); which content provider (e.g., broadcaster, television network) the program originates from; and a description of the program.

Existing transmission standards continue to evolve, while new transmission standards are adopted. Using television as an example, particular transmission standards include ATSC (Advanced Television Systems Committee); NTSC (National Television Standards Committee); PAL (Phase Alternation Line); SECAM (Sequentiel Couleur Avec Memoire, or Sequential Color with Memory); and DVB (Digital Video Broadcasting). Certain transmission standards may be based on other transmission standards—for example SECAM is based on PAL. Transmission standards may also define specific rules or information pertaining to specific transmission mediums (satellite, terrestrial, and cable). An example of this is DVB-T for terrestrial (i.e., radio frequency or RF antenna) transmission, DVB-C for cable transmission, and DVB-S for satellite transmission.

Transmission standards are typically implemented and specific to particular regions of the world—for example, PAL and DVB are widely used in Europe, while NTSC is used in the United States. In certain situations, a particular transmission standard in applicable to a particular transmission medium—for example, a receiving device may only receive DVB-S broadcast transmission signals, and does not need to implement DVB-T or DVB-C.

Transmission standards define how in-band data is carried over a broadcast transmission signal, such as the format of the in-band data. In other words in-band data payload is defined by protocols of the particular transmission standards.

In general, the different transmission standards (e.g., ATCS, DVB, NTSC) are not compatible with one another, and particular receiving devices such as television tuners and personal computers are configured to use a certain transmission standard. Therefore, if a transmission standard specific receiving device is used in an environment (i.e., different region of the world) that broadcasts broadcast transmission signals using a different transmission standard, the receiving device is unable to process the data in the broadcast transmission signal.

### SUMMARY

A multi-standard receiving device receives multiple broadcast transmission signals that are broadcasted using different transmission standards. For a particular received broadcast transmission signal, the multi-standard receiving device determines the transmission standard over which the broadcast transmission signal is broadcasted. The multi-transport receiving device parses metadata in the received broadcast transmission signal using protocols defined by the transmission standard.

### BRIEF DESCRIPTION OF THE CONTENTS

The detailed description is described with reference to the accompanying figures. In the figures, the left-most digit(s) of a reference number identifies the figure in which the reference number first appears. The use of the same reference numbers in different figures indicates similar or identical items.

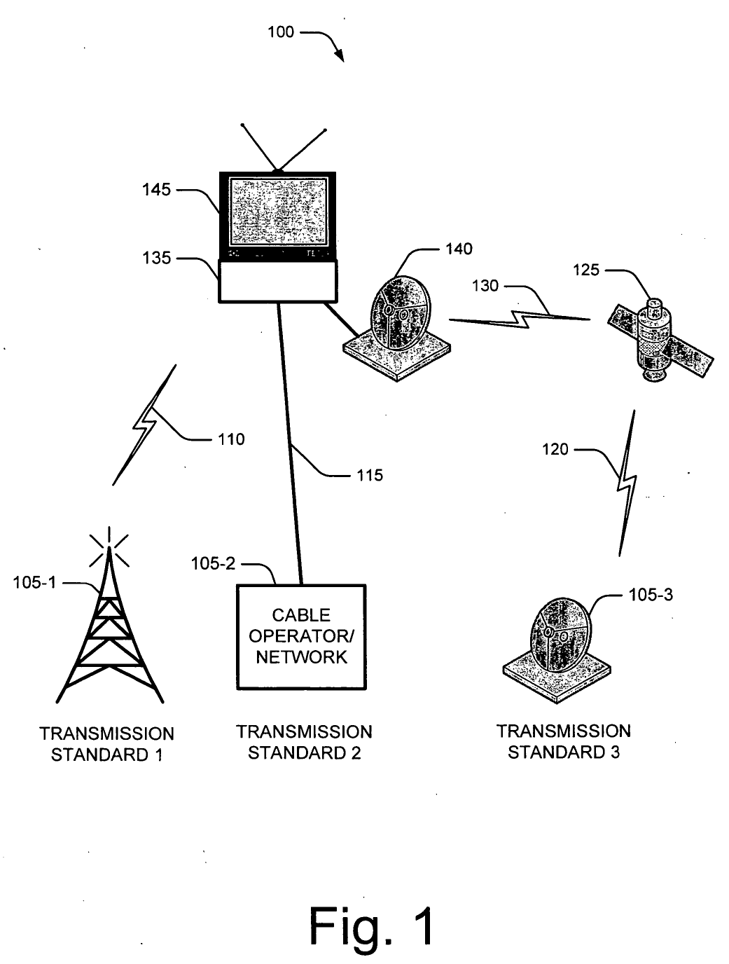

FIG. 1 illustrates a system with a multi-standard receiving device capable of receiving and processing multiple broadcast transmission signals using different transmission standards.

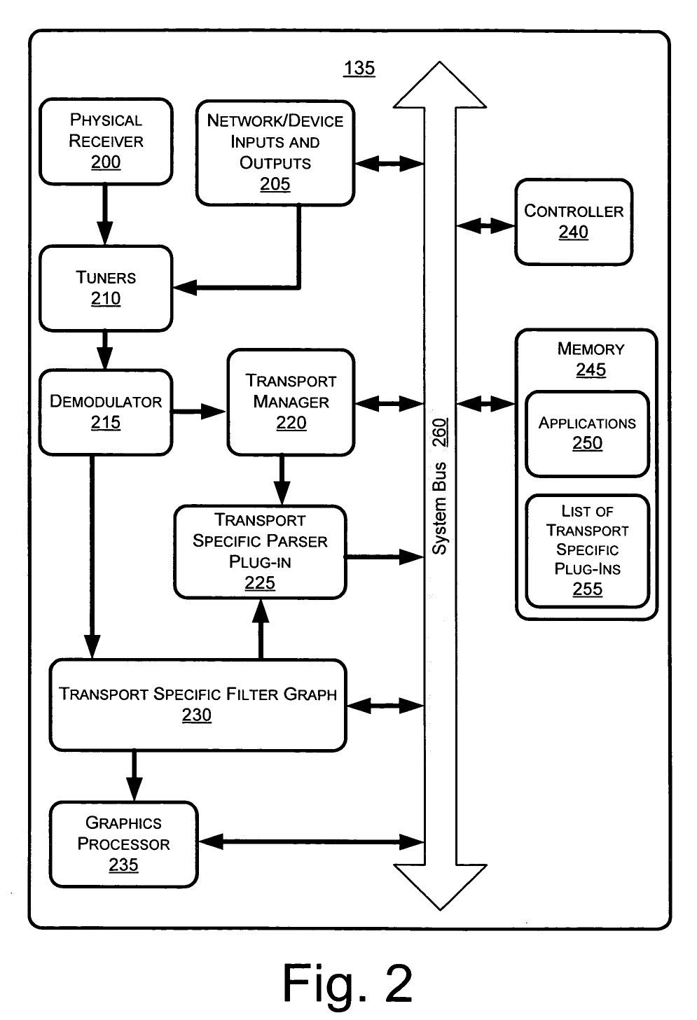

FIG. 2 is a block diagram of the multi-standard receiving device.

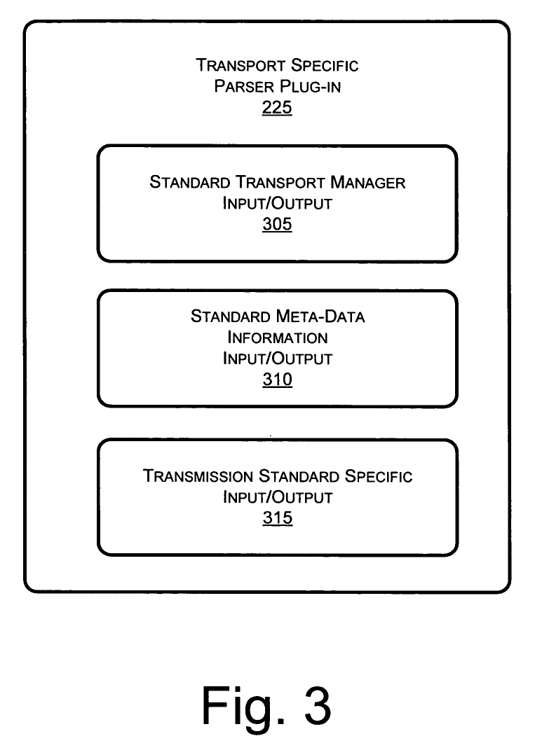

FIG. 3 is a block diagram of a transport specific parser plug-in that supports a particular transmission standard.

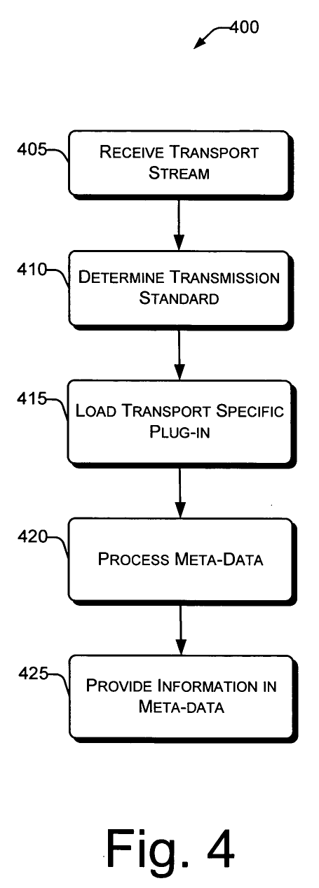

FIG. 4 is a flow diagram showing a process to receive a broadcast transmission signal based on a particular transmission standard, and process metadata included in the broadcast transmission signal.

### DETAILED DESCRIPTION

The following disclosure describes a multi-standard receiving device capable of receiving different broadcast transmission signals implementing different transmission standards from various broadcasters. A particular broadcast transmission signal based on a particular transmission standard is processed by a transport specific parser that processes metadata included in the broadcast transmission signal.

FIG. 1 shows an exemplary transmission system 100. System 100 includes multiple content providers or broadcasters 105-1, 105-2, and 105-3. The description uses as an example television transmission, broadcast transmission signals, and transmission standards; however, it is contemplated that other forms of transmission may be used such as data, radio, and non-television media transmissions.

In this example, each of broadcasters 105 transmits using a different transmission standard 1, transmission standard 2, and transmission standard 3. Examples of such transmission standards include ATSC, NTSC, SECAM, DVB, and ISDB (Integrated Services Digital Broadcasting). Broadcast transmission signals may be sent as RF (radio frequency) transmissions, satellite, digital or cable transmissions, or other forms of communication transmissions.

Broadcaster 105-1 is a terrestrial broadcaster that transmits an RF signal 110. Broadcaster 105-2 is a cable operator or cable network broadcaster that provides a cable signal 115. Broadcaster 105-3 is a satellite broadcaster that transmits a satellite uplink signal 120 received by a satellite 125. Satellite 125 transmits a downlink signal 130.

A multi-standard receiving device 135 receives signals 110, 115 and 130. In this example multi-standard receiving device 135 is connected to a satellite receiving dish 140 that receives downlink signal 130 which is passed on to multi-standard receiving device 135.

Whereas prior receiving devices are typically configured to receive and process broadcast transmission signals based on a particular transmission standard, multi-standard receiving device 135 is configured to be able to receive and process multiple broadcast transmission signals based on different transmission standards. In particular, multi-standard receiving device 135 is able to process metadata from broadcasters 105, where the metadata may be part of a broadcast transmission signal (in-band) or transmitted separate (out-band) from the broadcast transmission signal. In an implementation, multi-standard receiving device 135 provides for plug-in parser module that is loaded or created to particularly process metadata. This is discussed in further detail below.

Multi-standard receiving device 135 may be a television “tuner”, a television set top box, a cable television box, a digital video recorder, a personal computer (PC), or any device capable of receiving a broadcast transmission signal.

In this implementation, multi-standard receiving device 135 is connected to a display device 145 which may be a television monitor or computer monitor. In other implementations, multi-standard receiving device 135 and display device 145 may be an integrated unit.

FIG. 2 shows exemplary multi-standard receiving device 135 in greater detail. Multi-standard receiving device 135 includes a physical receiver 200 to receive broadcast transmission signals (i.e., signals 110, 115, and 130). Physical receiver 200 may be an RF antenna, a satellite dish (e.g. satellite dish 140), or other receiving device, to receive RF signals, satellite signals, microwave signals, or other types of communication/transmission signals.

Broadcast transmission signals from a network (e.g., cable network 105-2) are received by multi-standard receiving device 115 through network/device inputs and outputs (I/O) 205 which may include coaxial input/output, an Ethernet input/output, and/or other types of communication/data inputs and outputs.

Broadcast transmission signals received by physical receiver 200 and/or through I/O 205 are passed to tuners 210. Tuners 210 include one or more tuners that support particular transmission broadcasts from broadcasters 105. Each tuner of tuners 200 is tied to a particular transmission standard. Therefore in operation, multi-standard receiving device 135 uses a specific tuner of tuners 210 when receiving broadcast transmission signals from one of broadcasters 105 of FIG. 1 employing a particular transmission standard. The specific tuner that is active (or becomes activated) may be tuned to a particular frequency in which the broadcast transmission signal is received.

In general, an analog base-band signal which is a single signal is provided by the specific tuner of the tuners 210 to a demodulator 215. Demodulator 215 samples the analog base-band signal and converts it to a digital bit-stream. The digital bit-stream may contain audio, video, and/or metadata. A digital bit-stream may also be received by tuners 210, such that the demodulator 215 does not have to further perform any action—the received digital bit-stream is merely passed on by demodulator 215.

The digital bit-stream is sent to and received by a transport manager 220. The transport manager 220 is configured to determine the transmission standard that the digital stream uses. In other words, the transmission standard in which the originating broadcast transmission signal was broadcasted. Certain implementations of transport manager 220 may include sampling the digital bit stream and determining the transmission standard based on the sample of the digital bit-stream. In particular implementations, transport manager 220 may be configured to read at least a part of the digital bit-stream describing the transmission standard that is used. For example, broadcast transmission signals regardless of the transmission standard that is used may include a portion that describes and can be read by transport manager 220 without further processing.

A particular transmission standard or transport specific parser plug-in 225 is installed based on the determination performed by the transport manager 220. Transport specific parser plug-in 225 may be selected from multiple transport specific parser plug-ins each of which supports a particular transmission standard. In certain implementations, transport specific parser plug-in 225 is created from an application.

Transport specific parser plug-in 225 may be implemented as a software object or module. In other implementations transport specific plug-in module 225 may be hardware, firmware, software, or a combination. Transport specific parser plug-in 225 is described in further detail below.

A transmission standard or transport specific filter graph 230 may process audio, video, and meta data. A digital bit-stream may be sent from demodulator 215 to transport specific filter graph 230. The digital bit-stream is separated and processed into audio, video, and data components by filter graph 230. In certain cases, metadata may be sent from transport specific filter graph 230 to transport specific parser plug-in 225 for processing.

Transport manager 220 may initiate and install a particular transport specific filter graph 230 based on the transmission standard determined by the transport manager 220. Transport specific filter graph 230 may be defined by DirectShow® API (application program interface) by the Microsoft Corporation. DirectX® SDK (software development kit) by the Microsoft Corporation may also be used to create the transport specific filter graph 230.

Video or formatted sequence of pictures from transport specific filter graph 230 may be passed on to a graphics processor 235 that renders a video format. Among the different functions provided by the graphics processor 235 is a function that allows an electronic program guide (EPG) user interface that represents multiple entries of information gathered from multiple broadcast transmission signals of metadata.

Multi-standard receiving device 135 further includes a central processing unit or controller 240. In general, controller 240 is used to initiate components of multi-standard receiving device 135; process applications and run programs that are resident at or received by multi-standard receiving device 135; and fetch data and instructions from a memory 245.

The transport manager 220 may be particularly processed and ran by controller 240. Furthermore, transport specific filter graph 230 may be created and processed by controller 240 by implementing DirectShow® API, DirectX® SDK and/or other applications.

Memory 245 stores applications 250. Furthermore, the multiple transport specific parser plug-ins from which parser plug-in 225 is chosen from and installed is stored as a part of a list of transport specific plug-ins 255 which may be a database. Memory 245 includes random access memory (RAM); read only memory (ROM) such as flash and electrically erasable program ROM (EEPROM) memory; hard disk memory (i.e., storage devices); and/or transportable memory (e.g., read/write optical disc). Typically, RAM may be used to store a representation of filter graphs (e.g., transport specific filter graph 230) when a filter graph is created to process audio, video, and metadata.

A system bus 260 allows controller 240 and other components of multi-standard receiving device 135 to communicate with one another. System bus 260 further allows components to interface with I/O 205 to other devices external to multi-standard receiving device 135. The system bus 260 may be implemented as one or more of any of several types of bus structures, including a memory bus or memory controller, a peripheral bus, an accelerated graphics port, or a local bus using any of a variety of bus architectures. By way of example, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

FIG. 3 shows exemplary transport specific parser plug-in 225. Transport specific parser plug-in 225 includes pre-defined interfaces which are common to the multiple transport specific parser plug-ins.

In particular, transport specific parser plug-in 225 includes common or standard transport manager input/output 305 that allows transport manager 220 to call and load a particular transport specific parser plug-in 230 from the list 255. In certain implementations, when a transport specific parser plug-in 230 is created, through input/output 305, transport manager 220 installs the created transport specific parser plug-in 230 using input/output 305. Input/output 305 may be implemented as software code routines that call or connect a particular transport specific parser plug-in 230.

Based on protocols, algorithms, and routines that are particular to a transmission standard, transport specific parser plug-in 225 processes metadata which may be part of a transmitted broadcast transmission signal that includes audio and video, or sent as a separate broadcast transmission signal. The processed metadata is sent from transport specific parser plug-in 225 to system bus 260 through standard metadata information input/output 310. Input/output 310 may be implemented as software code routines that call or connect a particular transport specific parser plug-in 230.

The processed metadata may include data entries particular to a broadcast transmission signal. In certain cases, particularly during initialization of multi-standard receiving device, processed metadata may include information related to configuring to multi-standard receiving device 135 to receive a broadcasted broadcast transmission signal (e.g., frequency or channel) in which to tune the multi-standard receiving device 135. In other cases, such as when digital streams of programs are received, the information in the processed metadata may convey program scheduling information, service information, and events such as emergency broadcasts. Input/output 310 which are common or standard for multiple transport specific parser plug-ins 225 allows processed metadata to be sent to system bus 260. In other instances, transport specific filter graph 230 uses input/output 310 to send data for processing to transport specific parser plug-in 225. Therefore, regardless of whatever transport specific parser plug-in 225 is used, the components (e.g., system bus 260) of multi-standard receiving device 135 are able to communicate with (i.e., receive information from) transport specific parser plug-in 225.

For particular transmission standards, specific communication protocols may be needed to receive metadata or digital bit-streams containing metadata. Transmission standard specific input/output 315 is provided to allow a particular transport specific parser plug-in 225 to receive particular transmission standard metadata. Input/output 315 may be implemented as software code routines that call or connect a particular transport specific parser plug-in 230.

In the case of proprietary transmission standards, the transport specific parser plug-in 225 is provided by an originating or controlling party that defines the transmission standard. When a proprietary transmission standard is implemented, the originating or controlling party defines and determines how the transport specific parser plug-in 225 processes metadata. In effect, the proprietary transport specific parser plug-in 225 acts as a “black box” in which the actual processes that are performed are not necessarily known to other components; however, the use of common interfaces allows other components to pass and receive information from transport specific parser plug-in 225 regardless of the transmission standard.

FIG. 4 shows a process 400 to receive a broadcast transmission signal based on a particular transmission standard and process metadata by providing a transport specific plug-in. The process 400 takes place whenever a receiving device (e.g., multi-standard receiving device 135) receives a broadcast transmission signal that includes metadata.

The process 400 is illustrated as a collection of blocks in a logical flow graph, which represent a sequence of operations that can be implemented in hardware, software, or a combination thereof. In the context of software, the blocks represent computer instructions that, when executed by one or more processors, perform the recited operations. The process 400 is described with reference to multi-standard receiving device 135 of FIG. 2, although the process may be implemented in other devices.

At block 405, multi-standard receiving device 135 receives a broadcast transmission signal that may in the form or one or more communication signals (e.g., signals, 110, 115, and 130 of FIG. 1) which may be an analog RF signal, a digital signal from a network, satellite signal, microwave signal and any other communication signal. The broadcast transmission signal particularly includes metadata. The broadcast transmission signal is transmitted from broadcasters 105 using a particular television transmission standard. The broadcast transmission signal is received at physical receiver 200 or through an I/O 205, and to tuner(s) 210.

At block 410, a determination is made as to a transmission standard in which the broadcast transmission signal is broadcasted. Examples of transmission standards, and particular to television transmission, include ATSC, SECAM, NTSC, PAL, DVB, and ISDB. The determination may be made by transport manager 220 based on a particular tuner of tuners 210 dedicated to certain transmission standard. In certain cases, a portion of the broadcast transmission signal may be read without additional processing to determine the transmission standard that is used. For example transport manager 220 may be able to read a header portion of the broadcast transmission signal to determine the transmission standard.

At block 415, a particular transport specific parser plug-in is loaded (i.e., installed) by the transport manager 220 based on the determination performed at block 410. The particular transfer specific parser plug-in may be stored in the list of transport specific parser plug-ins 255. The particular transfer specific parser plug-in is called from the list 255 and installed when needed by the transmission standard that is supported. In other cases, a transport specific parser plug-in may be created and installed.

At block 420, the particular parser plug-in processes (i.e., parses) the metadata in the received broadcast transmission signal. The processing is based on particular protocols, algorithms, and/or routines specific to the transmission standard in which the broadcast transmission signal is broadcasted. In certain cases, the protocols, algorithms, and/or routines are proprietary, and in other cases they are not.

At block 425, the processed metadata is made available or provided to other components of multi-standard receiving device 135, such as storing metadata information in memory. Standardized input and outputs such as input/output 310, the processed metadata information may be used by components of multi-standard receiving device 135.

### CONCLUSION

The above-described multi-standard receiving device receives metadata that is processed or parsed by a transmission standard specific parser. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A multi-standard receiving device comprising:
a tuner that receives a broadcast transmission signal;
a transport manager that determines the transmission standard used by the broadcast transmission signal; and
a transport specific parser that is loaded by the transport manager based on the transmission standard that is determined, to process metadata included in the broadcast transmission signal.

2. The multi-standard receiving device of claim 1, wherein the transmission standard applies to one of the following: television, radio, and data service.

3. The multi-standard receiving device of claim 1, wherein the broadcast transmission signal is received from one of the following a terrestrial broadcaster, a cable broadcaster, and a satellite broadcaster.

4. The multi-standard receiving device of claim 1, wherein the broadcast transmission signal is received as one of the following signals RF, satellite, and microwave.

5. The multi-standard receiving device of claim 1, wherein the transport manager determines the transmission standard based on the tuner, wherein the tuner is particular to the transmission standard.

6. The multi-standard receiving device of claim 1, wherein the transport manager determines the transmission standard based on a portion of the received broadcast transmission signal.

7. The multi-standard receiving device of claim 1, wherein the transport specific parser comprises predefined inputs and outputs independent of the transmission standard.

8. The multi-standard receiving device of claim 1, wherein the transport specific parser is selected and installed from multiple transport specific parsers.

9. The multi-standard receiving device of claim 1, wherein the transport specific parser provides the processed metadata information to a memory in the multi-standard receiving device.

10. The multi-standard receiving device of claim 1, wherein the processed metadata comprises one or more of the following: broadcaster information, program information, emergency information, and tuning information.

11. A method of processing metadata comprising:
receiving a broadcast transmission signal that includes metadata;
determining a transmission standard used to broadcast the received broadcast transmission signal from multiple transmission standards that are supported; and
parsing the metadata in the broadcast transmission signal based on the determined transmission standard.

12. The method as recited in claim 11, wherein the receiving is from a terrestrial, cable, or satellite broadcaster source.

13. The method as recited in claim 11, wherein the transmission standard applies to one of the following: television, radio, and data service.

14. The method as recited in claim 11, wherein the transmission standard is one of the ATSC, SECAM, NTSC, PAL, DVB, and ISDB.

15. The method of as recited in claim 11, wherein the receiving is performed by a transmission standard specific tuner and the determining is based on the transmission standard specific tuner.

16. The method of as recited in claim 11, wherein the determining is based on information in the received broadcast transmission signal that describes the transmission standard.

17. The method of as recited in claim 11, wherein the determining is performed by a transport manager.

18. The method as recited in claim 11, wherein the parsing is performed by a transport specific parser plug-in that is installed when the transmission standard is determined.

19. The method as recited in claim 11 further comprising storing the parsed metadata with other parsed metadata.

20. One or more computer-readable media comprising computer-executable instructions that, when executed, perform the method as recited in claim 11.

21. For use with a receiving device, a storage medium having instructions that, when executed on the receiving device, performs acts comprising:
receiving one or more broadcast transmission signals, wherein each of the broadcast transmission signals is based on a particular transmission standard;
determining a transmission standard for a received broadcast transmission signal that includes metadata; and
processing the metadata based on the determined transmission standard.

22. A storage medium as recited in claim 21, wherein the receiving is one of following signal types: RF, cable, satellite, and microwave.

23. A storage medium as recited in claim 21, wherein the determining comprises sampling the received broadcast transmission signal.

24. A storage medium as recited in claim 21, wherein the processing comprises installing a transmission standard specific plug-in from multiple plug-ins.

25. A processing of a metadata in transport comprising:
receiving means for receiving a transmission standard specific broadcast transmission signal of multiple transmission standard specific broadcast transmission signals;
determining means for determining the transmission standard of the received broadcast transmission signal; and
parsing means for processing the metadata.

26. The processing as recited in claim 25 further comprising providing means for providing information in the processed metadata.

27. The processing as recited in claim 26 further comprising creating means for creating a guide that includes the information.
